(19) United States
(12) Patent Application Publication
(10) Pub. No.: US 2012/0002041 A1
(43) Pub. Date: Jan. 5, 2012

(54) Golf Ball Finder

(75) Inventor: Allen Nejah, San Jose, CA (US)

(73) Assignee: SUNMAN ENGINEERING, INC., San Jose, CA (US)

(21) Appl. No.: 12/830,225

(22) Filed: Jul. 2, 2010

(51) Int. Cl. H04N 7/18

(52) U.S. Cl. 348/135; 348/61; 348/E05.09; 348/E07.085

(57) ABSTRACT

A golf ball finder includes a thermal imaging camera or sensor, a display, a nonvolatile memory storing golf ball detection software, and a processor for executing the golf ball detection software. The processor is programmed to locate a golf ball by causing the thermal imaging camera or sensor to capture a thermal image of a golf course, searching the thermal image for one or more thermal signatures of the golf ball, and, when the golf ball is located, providing an indicator guiding a user toward the golf ball.

### FIELD OF INVENTION

This invention relates to method, apparatus, and technique for finding golf balls.

### DESCRIPTION OF RELATED ART

Golfers often lose sight of their golf balls. Several devices have been devised to locate golf balls. The Visiball sunglasses have special pigments in the lenses that help to make white golf balls standout from the background. The Ballfinder Scout scans the playing field and looks for the unique color signature (visible spectrum) of white golf balls. RadarGolf Handheld transmits a first radio frequency (RF) signal and detects a second RF signal returned from a golf ball equipped with a microchip in response to the first RF signal.

### BRIEF DESCRIPTION OF THE DRAWINGS

In the drawings:

FIG. 1 is a block diagram of a thermal imaging golf ball finder in one or more embodiments of the present disclosure;

FIG. 2 illustrates a dramatized thermal image in one or more embodiments of the present disclosure;

FIG. 3 is a flowchart of a method for the golf ball finder of FIG. 1 to locate a golf ball in one or more embodiments of the present disclosure;

FIG. 4 is a block diagram of a thermal imaging flow meter in one or more embodiments of the present disclosure;

FIG. 5 illustrates dramatized thermal images in one or more embodiments of the present disclosure; and

FIG. 6 is a flowchart of a method for the thermal imaging flow meter of FIG. 4 to determine flow rate in a pipe in one or more embodiments of the present disclosure.

Use of the same reference numbers in different figures indicates similar or identical elements.

### DETAILED DESCRIPTION

In one or more embodiments of the present disclosure, a golf ball finder includes a thermal imaging camera or sensor, a display, a nonvolatile memory storing golf ball detection software, and a processor for executing the golf ball detection software. The processor is programmed to locate a golf ball by causing the thermal imaging camera or sensor to capture a thermal image of a golf course, searching the thermal image for one or more thermal signatures of the golf ball, and, when the golf ball is located, providing an indicator guiding a user toward the golf ball.

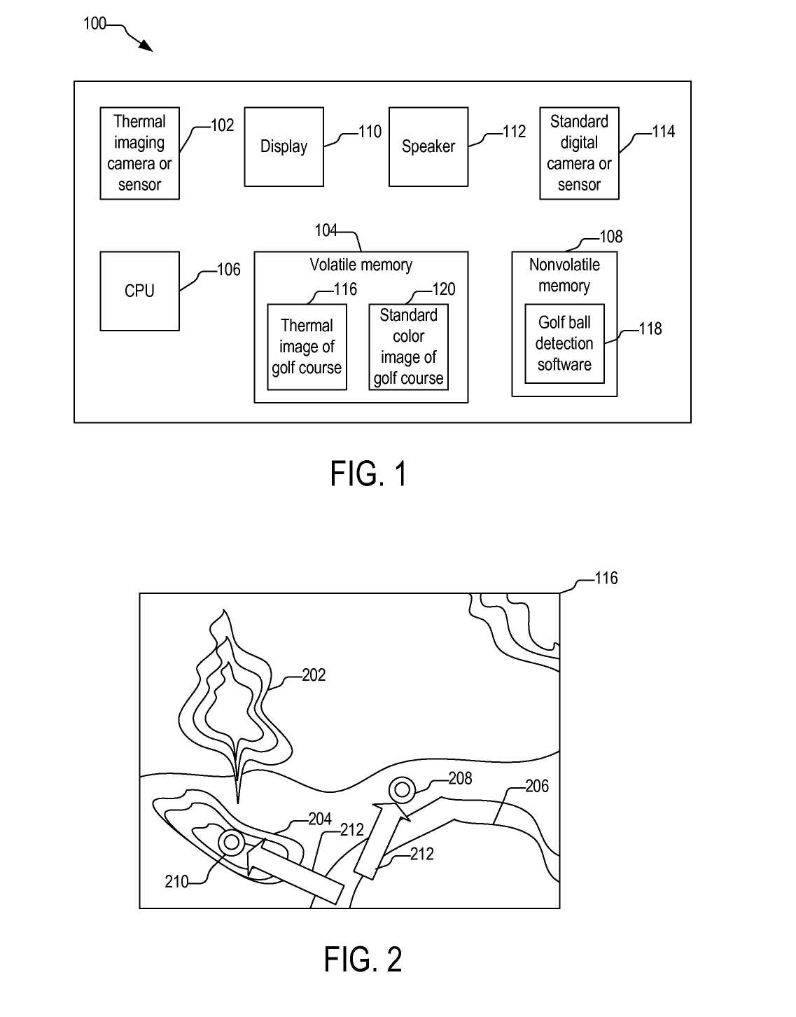

FIG. 1 is a block diagram of a thermal imaging golf ball finder 100 in one or more embodiments of the present disclosure. Golf ball finder 100 includes a thermal imaging camera or sensor 102 (hereafter simply as “thermal imaging camera 102”), a volatile memory 104, a processor 106, a nonvolatile memory 108, a display 110, a speaker 112, and a standard digital camera or sensor 114 (hereafter simply as “standard digital camera 114”). Thermal imaging camera 102 is used to capture a thermal image 116 of a golf course. Thermal image 116 is temporarily stored in volatile memory 104 to be processed by processor 106. Processor 106 runs a golf ball detection software 118 stored in nonvolatile memory 108 and loaded into volatile memory 104 for execution.

Golf ball detection software 118 detects a golf ball in thermal image 116 based on one or more thermal signatures of the golf ball, and provides one or more indicators that guide the user toward the golf ball. The golf ball may have a thermal signature consisting of a circular object distinct from its surroundings or two or more concentric circular objects distinct from their surroundings. The two or more concentric circular objects represent multiple cores and layers of the golf ball. In addition to golf balls, golf ball detection software 118 may detect other objects using their thermal signatures. These other objects include golf clubs and sunglasses.

Processor 106 may provide, on display 110, a visual indicator around the golf ball in thermal image 116 or the visual indicator in a corresponding color image 120 to guide a user toward the golf ball. Processor 106 may also overlay thermal image 116 with the visual indicator on color image 120. Color image 120 may be captured by thermal imaging camera 102 or standard digital camera or sensor 114. Processor 106 may also provide an audio indicator to guide the user toward the golf ball. For example, processor 106 may cause a speaker 112 to emit rapid beeps when golf ball finder 100 is pointed toward the golf ball (when the golf ball is located in the center of thermal image 116) and slow beeps when the golf ball finder 100 is pointed away from the golf ball (when the golf ball is located in near the sides of thermal image 116).

FIG. 2 illustrates a dramatized thermal image 116 in one or more embodiments of the present disclosure. In thermal image 116 are a tree 202, a sand trap 204, a water hazard 206, a golf ball 208 in plain sight, and a golf ball 210 in the sand trap. Note that golf ball 210 has a thermal signature that appears as a round object even though it may be half buried in sand.

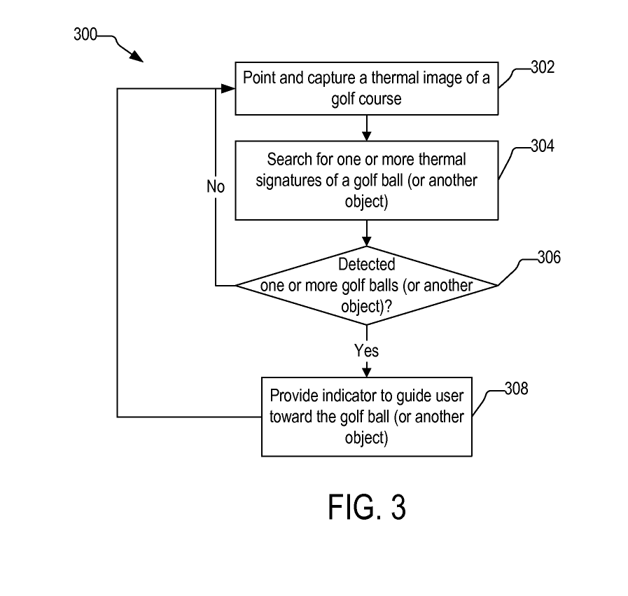

FIG. 3 is a flowchart of a method 300 for golf ball finder 100 (FIG. 1) to locate a golf ball in one or more embodiments of the present disclosure. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation. Method 300 may begin in block 302.

In block 302, thermal image 116 of a golf course is captured. Processor 106 may cause thermal imaging camera 102 to capture thermal image 116 in response to a user command (e.g., pressing a button after pointing golf ball finder 100 at the golf course), and temporarily store the thermal image in volatile memory 104. Block 302 may be followed by block 304.

In block 304, one or more thermal signatures of a golf ball are searched for on thermal image 116 to locate one or more golf balls. The thermal signatures of the golf ball include a fully circular object. Processor 106 may use a pattern recognition technique to detect the thermal signatures of the golf ball in thermal image 116. One or more thermal signatures of another object are searched for on thermal image 116 to locate the other object. Block 304 may be followed by block 306.

In block 306, it is determined if one or more golf balls (or another object) have been detected in thermal image 116. If so, block 306 may be followed by block 308. Otherwise block 306 may be loop back to block 302 to repeat the process on another thermal image. Processor 106 may make the determination in block 306 based on the result of block 304.

In block 308, one or more indicators are provided to guide the user toward the one or more golf balls (or another detected object). Processor 106 may generate the one or more visual indicators on thermal image 116, color image 120 (FIG. 2), or a composite image of the thermal image over the color image on display 110. A visual indicator may be a halo around a golf ball or an arrow 212 (FIG. 2) pointing to a golf ball. Processor 106 may also cause speaker 112 to emit rapid beeps when golf ball finder 100 is pointed toward the golf ball (when the golf ball is located in the center of thermal image 116) and slow beeps when the golf ball finder 100 is pointed away from the golf ball (when the golf ball is located in near the sides of thermal image 116). Block 308 may be loop back to block 302 to repeat the process on another thermal image. The process may be performed in real-time to guide the user toward the one or more detected golf ball.

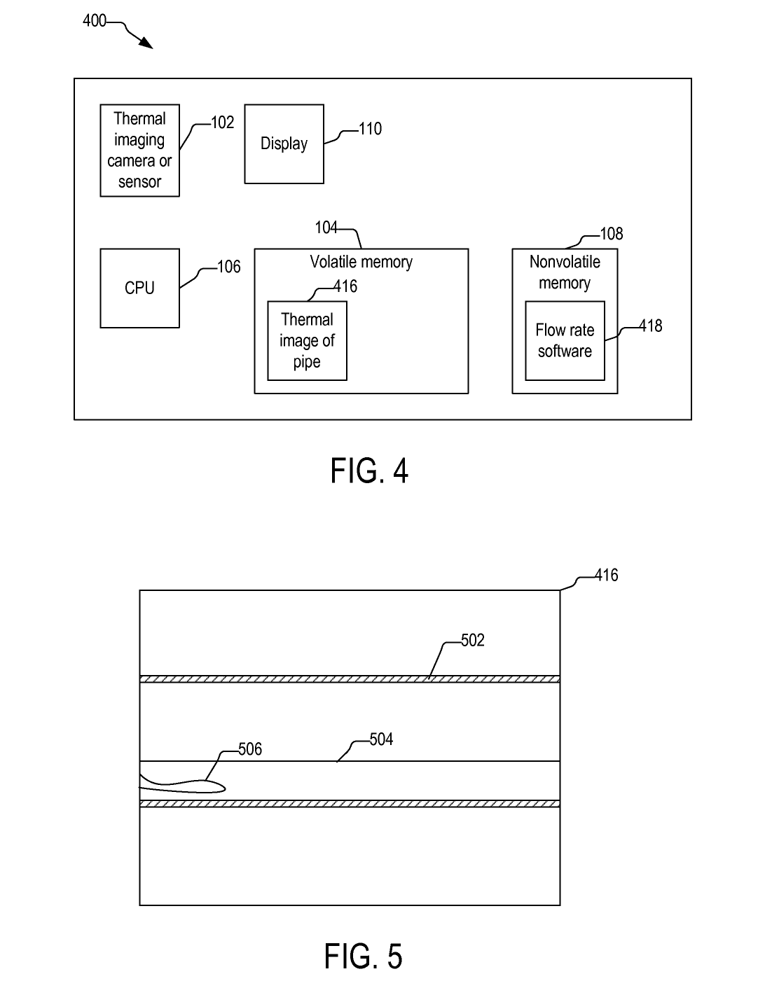

FIG. 4 is a block diagram of a thermal imaging flow meter 400 in one or more embodiments of the present disclosure. Thermal imaging flow meter 400 includes thermal imaging camera or sensor 102, volatile memory 104, processor 106, nonvolatile memory 108, and display 110. Thermal imaging camera 102 is used to capture a thermal image 416 of a pipe. Thermal image 416 is temporarily stored in volatile memory 104 to be processed by processor 106. Processor 106 runs a flow meter software 418 stored in nonvolatile memory 108 and loaded into volatile memory 104 for execution.

Flow meter software 118 determines the flow rate in a pipe based on thermal image 416. Flow rate software 118 determines the radius or diameter of the pipe and the height and the velocity of a fluid in the pipe, and then determines the flow rate from the pipe radius or diameter, the fluid height, and the fluid velocity. Optionally the user provides the pipe radius or diameter to flow rate software 118. Processor 106 may provide thermal image 416 on display 110 along with the determined flow rate in the pipe.

FIG. 5 illustrates a dramatized thermal image 416 in one or more embodiments of the present disclosure. Thermal image 416 includes a pipe 502 and a first fluid (e.g., water) 504 flowing through the pipe at a different temperature than the pipe. Also shown is a moving front of a second fluid 506 of the same type as first fluid 504 (e.g., water). Second fluid 506 is at a warmer or cooler temperature than first fluid 504 and the second fluid is introduced into pipe 502 to determine the velocity of first fluid 504.

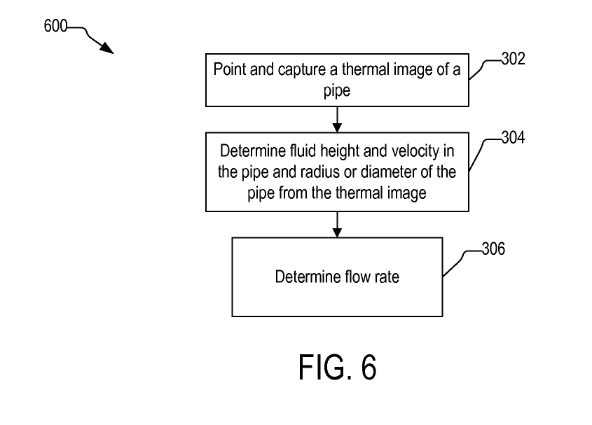

FIG. 6 is a flowchart of a method 600 for thermal imaging flow meter 400 (FIG. 4) to determine the flow rate in pipe 502 in one or more embodiments of the present disclosure. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation. Method 600 may begin in block 602.

In block 602, a series of thermal images 416 of pipe 502 is captured. Processor 106 may cause thermal imaging camera 102 to capture thermal images 416 at a predetermined frame rate in response to a user command (e.g., pressing a button), and temporarily store the thermal images in volatile memory 104. After thermal imaging camera 102 starts to capture thermal images 416, the user introduces second fluid 506 into pipe 502. Thermal imaging camera 102 captures a sufficient number of thermal images 416 to detect the velocity of the moving front of fluid 506. Block 602 may be followed by block 604.

In block 604, the height of fluid 504 in pipe 502, the radius or diameter of the pipe, and the velocity of the fluid in the pipe are determined from one or more thermal images 416. Processor 106 determines the fluid height as a perpendicular distance between the top level of fluid 504 and the bottom of pipe 502. Processor 106 determines the pipe radius or diameter as a perpendicular distance between the top and the bottom of the pipe. Optionally the user provide the pipe radius or diameter. Processor 106 detects the moving front of fluid 506 in two or more thermal images 416 and then determines the fluid velocity from one or more distances traveled by the moving front in the thermal images and the predetermined frame rate of the thermal images. Block 606 may be followed by block 608.

In block 608, the flow rate in pipe 502 is determined. Processor 106 determines the cross-sectional area (e.g., a segment area) of fluid 504 in pipe 502 based on the fluid height and the pipe radius or diameter. Processor 106 then determines the flow rate based on the cross-section area and the fluid velocity.

Various other adaptations and combinations of features of the embodiments disclosed are within the scope of the present disclosure. Numerous embodiments are encompassed by the following claims.

What is claimed is:

1: A golf ball finder, comprising:
a thermal imaging camera or sensor;
a nonvolatile memory storing a detection software; and
a processor for executing the detection software, wherein the processor is programmed to locate a golf ball by:
causing the thermal imaging camera or sensor to capture a thermal image of a portion of a golf course;
searching the thermal image for one or more thermal signatures of the golf ball; and
when the golf ball is located, providing an indicator for the golf ball.

2: The golf ball finder of claim 1, further comprising a display, wherein said providing an indicator for the golf ball comprises providing a visual indicator on the display identifying the golf ball in a standard color image corresponding to the thermal image.

3: The golf ball finder of claim 2, further comprising a standard digital camera or sensor, wherein the processor is further programmed to locate the golf by causing the standard digital camera or sensor to capture the standard color image.

4: The golf ball finder of claim 1, further comprising a speaker, wherein said providing an indicator for the golf ball comprises providing an audio indicator with the speaker identifying the golf ball.

5: The golf ball finder of claim 4, wherein the processor is further programmed to locate the golf by causing the speaker to emit rapid beeps when the golf ball is located near the center of the thermal image and to emit slow beeps when the golf ball is located near a side of the thermal image.

6: The golf ball finder of claim 1, wherein the one or more thermal signatures of the golf ball include a round object and a partially round object.

7: The golf ball finder of claim 1, wherein the processor is programmed to locate an other object by:
searching the thermal image for one or more thermal signatures of the other object; and
when the other object is located, providing an other indicator for the other object.

8: The golf ball finder of claim 7, wherein the other object is a golf club.

9: A method for finding a golf ball, comprising:
capturing a thermal image of a golf course;
searching, using a programmed processor, the thermal image for one or more thermal signatures of a golf ball; and
when the golf ball is located in the thermal image, providing an indicator for the golf ball.

10: The method of claim 9, further said providing an indicator for the golf ball comprises providing a visual indicator on a display identifying the golf ball in a standard color image corresponding to the thermal image.

11: The method of claim 10, further capturing the standard color image.

12: The method of claim 9, wherein said providing an indicator for the golf ball comprises providing an audio indicator with the speaker identifying the golf ball.

13: The method of claim 12, wherein said providing an audio indicator comprises emitting rapid beeps when the golf ball is located near the center of the thermal image and emitting slow beeps when the golf ball is located near a side of the thermal image.

14: The method of claim 9, wherein the one or more thermal signatures of the golf ball include a round object and a partially round object.

15: The method of claim 9, further comprising:
searching the thermal image for one or more thermal signatures of another object; and
when the other object is located, providing another indicator for the other object.

16: The method of claim 15, wherein the other object is a golf club.

17: A flow rate meter, comprising:
a thermal imaging camera or sensor;
a nonvolatile memory storing a flow rate software; and
a processor for executing the flow rate software, wherein the processor is programmed to determine a flow rate in a pipe by:
causing the thermal imaging camera or sensor to capture two or more thermal images of the pipe;
determining a height of a fluid in the pipe from the thermal images;
determining a cross-sectional area of the fluid in the pipe from the height of the fluid in the pipe and a radius or diameter of the pipe;
determining a velocity of the fluid in the pipe from the thermal images; and
determining the flow rate of the fluid in the pipe based on the cross-sectional area and the velocity of the fluid in the pipe.

18: The flow rate meter of claim 17, wherein the processor is further programmed to determine the radius or diameter of the pipe from one or more of the thermal images or receive the radius or diameter of the pipe from a user.

19: The flow rate meter of claim 17, wherein determining the velocity of the fluid in the pipe from the thermal images comprises detecting a moving front of an other fluid in the thermal images and determining the velocity of the fluid in the pipe from distances traveled by the moving front in the thermal images and a frame rate of the thermal images, the other fluid being at a different temperature than the fluid.

20: The flow rate meter of claim 17, further comprising a display, wherein the processor further displays one or more of the thermal images and the determined flow rate on the display.

21: A method for determining a flow rate in a pipe, comprising:
causing a thermal imaging camera or sensor to capture two or more thermal images of the pipe;
determining a height of a fluid in the pipe from the thermal images;
determining a cross-sectional area of the fluid in the pipe from the height of the fluid in the pipe and a radius or diameter of the pipe;
determining a velocity of the fluid in the pipe from the thermal images; and
determining the flow rate of the fluid in the pipe based on the cross-sectional area and the velocity of the fluid in the pipe.

22: The method of claim 21, further comprising determining the radius or diameter of the pipe from one or more of the thermal images or receive the radius or diameter of the pipe from a user.

23: The method of claim 21, wherein determining the velocity of the fluid in the pipe from the thermal images comprises:
introducing an other fluid into the pipe, the other fluid being at a different temperature than the fluid;
detecting a moving front of the other fluid in the thermal images; and
determining the velocity of the fluid in the pipe from distances traveled by the moving front in the thermal images and a frame rate of the thermal images.

24: The method of claim 21, further comprising displays one or more of the thermal images and the determined flow rate.
